(19) United States
(12) Patent Application Publication
(10) Pub. No.: US 2015/0040830 A1
(43) Pub. Date: Feb. 12, 2015

(54) METHOD OF MECHANICALLY MILKING AN ANIMAL AND TEAT CUP LINER

(71) Applicant: GEA Farm Technologies GmbH, Bonen (DE)

(72) Inventors: Johannes Leendert van Leeuwen, Wageningen (NL); Pieter Hendrik Hogewerf, Wageningen (NL); Albertus Hendrik Ipema, Wageningen (NL); Cornelis Johannes Aloysius Marie de Koning, Wageningen (NL); Josephus Gerardus Maria van den Boogaart, Wageningen (NL); Marinus Cornelis van Turnhout, Wageningen (NL)

(21) Appl. No.: 14/385,477

(22) PCT Filed: Mar. 15, 2013
(86) PCT No.: PCT/NL2013/050184

§ 371 Date: Sep. 15, 2014

(30) Foreign Application Priority Data
Mar. 15, 2012 (NL) 2008492

(51) Int. Cl. A01J 5/16; A01J 5/04; A01J 5/02

(52) U.S. Cl. CPC A01J 5/16; A01J 5/02; A01J 5/047
USPC 119/14.02; 119/14.51

(57) ABSTRACT

Method of mechanically milking a lactating animal, such as a cow, a goat and a sheep, comprising: providing an animal having at least one teat (110), said teat comprising an elongate shaft (112) and a teat end (114) at an end of said shaft, said teat end comprising a teat canal (116) having an external orifice (118); milking the teat (110) by repeatedly alternatingly increasing and decreasing a diameter (D) of at least a longitudinal portion of its shaft (112), while maintaining a substantially axi-symmetric shape of said portion of the shaft, and while continuously applying a milking vacuum to the teat end (114) so as to extract milk from the external orifice (118) of the teat canal (116). Also disclosed is a teat cup liner for practicing the disclosed method.

### FIELD OF THE INVENTION

The present invention relates a method of mechanically milking a lactating animal, such as a cow, a goat and a sheep, and to a liner for a teat cup that may be employed in said method.

### BACKGROUND

Over the past century milking methods have been the subject of intensive research. The aim of this research has been to find (combinations of) milking parameters, such as liner design, pulsator settings and vacuum levels, that optimize milking characteristics and enable lactating animals to be milked gently, quickly and completely.

### SUMMARY OF THE INVENTION

The present invention aims to provide for a method of mechanically milking a lactating animal that offers improved milking characteristics relative to known methods, in particular reduced average milking time per cow, reduced frequency of liner slips, and improved teat condition.

Another object of the present invention is to provide for a teat cup liner that facilitates the execution of the method according to the present invention.

A first aspect of the present invention is therefore directed to a method of mechanically milking a lactating animal, such as, for example, a cow, a goat and a sheep. The method includes providing an animal having at least one teat, said teat comprising an elongate shaft and a teat end at an end of said shaft, said teat end comprising a teat canal having an external orifice. The method also comprises milking the teat by repeatedly alternatingly increasing and decreasing a diameter of at least a longitudinal portion of its shaft, while maintaining a substantially axi-symmetric shape of said portion of the shaft, and while continuously applying a preferably substantially constant milking vacuum to the teat end so as to extract milk from the external orifice of the teat canal.

During milking, the (outer) diameter of the massaged longitudinal portion of the teat shaft may generally vary from above a reference diameter associated with a natural pre-milking state of said shaft portion to below said reference diameter, and vice versa. In one embodiment, however, the method may comprise, before starting the milking, radially stretching the longitudinal portion of the shaft of the teat from a natural pre-milking state to a stretched state, and, thereafter, milking the teat while keeping the diameter of the longitudinal portion of the shaft above that of its natural pre-milking state. Yet, in an alternative, preferred embodiment, the method may comprise, before starting the milking, radially compressing the longitudinal portion of the shaft of the teat from a natural pre-milking state to a compressed state, and, thereafter, milking the teat while keeping the diameter of the longitudinal portion of the shaft below that of its pre-milking state.

The presently disclosed milking method may thus differ from known methods in at least one of the following aspects:
(i) during milking, a preferably substantially constant milking vacuum is continuously applied to the teat end (i.e. there is a continuous open fluid connection with the applied milking vacuum);
(ii) during milking, at least the massaged portion of the teat-shaft is kept in a substantially axi-symmetric shape; and
(iii) during milking at least the massaged portion of the teat shaft is maintained in a variable but continuous state of compression relative to its natural pre-milking state (preferred embodiment).

### Regarding Aspect (i)

The term ‘milking vacuum’ as used in this text refers to the vacuum at the teat end. Furthermore, unless expressly stated otherwise, the term ‘milking vacuum pressure’ refers to the mean pressure of the milking vacuum relative to atmospheric pressure, calculated as a time-average over an integer number of complete milking cycles. A milking cycle is understood to be the repetitive unit or building block of the milking process.

It should be noted that in particular the meaning of the term ‘milking vacuum pressure’ in this text may be different from the meaning that the term carries when used in the context of conventional milking methods. In that context, the term may typically refer to the average teat-end vacuum level during the b-phase or liner open/milking phase of pulsation (if it is used accurately), or to the system vacuum (if it is used less accurately). In conventional mechanical milking methods a teat is received in the liner of a teat cup, which liner ‘pulsates’, i.e. periodically collapses and typically closes below the teat end, to block milk flow and to relieve the teat from milking. The milking vacuum applied to the teat end in such a method is therefore not substantially constant (see definition below), and typically discontinuous. In the case of a discontinuous milking vacuum, the milking vacuum is thus only applied to the teat end during a part of a milking cycle; consequently, the teat-end vacuum pressure during the b-phase of pulsation may differ significantly from the average teat-end vacuum measured over one or more complete pulsation/milking cycles. As regards the alternative, less accurate conventional interpretation of the term milking vacuum pressure, it may be noted that a significant discrepancy between the system vacuum and the milking vacuum may arise due to the fact that the system vacuum is generally specified at a downstream point of the milk flow path through a milking machine, away from the teat cups, for example near the machine's receiver or vacuum regulator. Milk slugging through the milk tubes that connect the machine's vacuum system to its teat cups may cause fluctuations in vacuum levels along the milk flow path, and hence cause the teat-end pressure to systematically deviate from the system pressure. This deviation may depend strongly on the configuration of the specific milking machine. It is therefore not always possible to unequivocally relate the milking vacuum pressure stated in a publication relating to conventional milking methods to the milking vacuum pressure as defined above.

Unlike conventional milking methods, the presently disclosed method is based on the continuous application of a milking vacuum to the teat end. This means that, as far the milking vacuum/vacuum at the teat end is concerned, no distinction needs to be made between different ‘pulsation phases’, as, indeed, there is no pulsation in the sense of periodic milking vacuum/milk flow interruption; accordingly, the milking vacuum pressure may be calculated over an integer number of complete milking cycles. Despite its continuity, the pressure of the milking vacuum may still vary somewhat during the milking process as a result of milk slugging through the milk tubes. These variations may be reduced or prevented by using milk tubing with a sufficiently large inner diameter. In the presently disclosed method the pressure of the milking vacuum may preferably be ‘substantially constant’. That is, the milking vacuum may, at least on average (over a plurality of milking cycles), not vary by more than about a fourth, and preferably about a tenth, of its absolute mean value relative to atmospheric pressure within a milking cycle.

### As Regards Aspect (ii)

It is understood that a conventional milking cycle may typically include a liner collapse that non-axisymmetrically compresses at least the lower portion of a milked teat. In contrast, the presently disclosed method may be effected without liner collapses, and is thus capable of maintaining the teat end and the teat shaft in a less straining axi-symmetric shape.

For clarity, it is noted that the term ‘axi-symmetry’ as used in this text refers to infinite-fold rotational symmetry. That is, an object may be referred to as being axi-symmetric if it does not change when rotated by any (arbitrary) angle around its axis of symmetry. Or phrased otherwise, if the shape z of the object can be described as a function ƒ of the position along the axis of symmetry only, i.e. z=ƒ(x). As such, axi-symmetry should be distinguished from n-fold discrete rotational symmetry, with n being an integer. An object that possesses n-fold discrete rotational symmetry does not change as a result of rotation around its axis of symmetry only if it is rotated by a specific angle of (360/n) degrees. Thus, although the cross-sectionally polygonal barrels of the liners discussed in, for instance, US 2011/0,126,768-A1 (Grace et al.) and US 2009/0,084,319-A1 (Sellner) may be considered to possess n-fold discrete rotational symmetry, they cannot be regarded to be axi-symmetric.

Furthermore, it may be noted that the term ‘collapse’ as used in this text to describe a (conventional) collapsing liner may be construed to refer to a typically rapidly occurring, non-axisymmetric deformation of the liner, in particular at least near the teat end and/or below the teat end. In conventional milking methods, a collapse of the liner may oftentimes cause previously non-touching wall parts of the liner to move towards each other and touch each other, and even effect complete or near-complete closure of the liner below the teat end.

Regarding Aspect (iii)

Both in conventional milking methods and in the presently disclosed method the teat shaft may be periodically massaged to vary its outer diameter.

The massaging in the presently disclosed method may typically be quantitatively defined in terms of the parameters D, Dₙ, D_{osc,mean}, and D_{osc,ampl}. Here D denotes the momentary length-averaged outer diameter of the longitudinal portion of the teat shaft that is massaged during milking. The length-average is taken over the length of the longitudinal portion of the shaft. Any diameter variations imposed upon the shaft portion, in particular through radial compression, may be substantially circumferentially uniform, such that at least said portion of the shaft maintains its generally cylindrical, axi-symmetric shape and D approximates the actual outer diameter thereof. Dₙ is the pre-milking value of D when the teat is still in a natural state, i.e. when the teat has not yet been inserted into a teat cup liner. D_{osc,mean} is the time average of D during milking; the time average may be taken over an integer number of complete milking cycles. D_{osc,ampl} denotes the maximum absolute deviation of D from D_{osc,mean} during milking.

The massaged portion of the shaft may typically extend from/include the teat end. Furthermore, in a preferred embodiment, the massaged longitudinal portion of the teat shaft may cover at least 50%, and more preferably at least 75% of the length of the teat, wherein the teat length is measured from a base of the shaft to the external orifice of the teat canal.

As mentioned above, in a preferred embodiment of the presently disclosed method, the massaged portion of the teat shaft is kept in a continuous state of compression, whose extent of compression may preferably be generally large. In one embodiment of the method, the outer diameter D of the massaged shaft portion is oscillated about a mean value D_{osc,mean}<0.90·Dₙ. In a preferred embodiment, D_{osc,mean}<0.875·Dₙ. Hence, over the milking period the natural diameter of the massaged portion of the teat may, on average, be reduced by more than 10% and 12.5%, respectively. To ensure continuous compression of the teat shaft (i.e. D<Dₙ), the amplitude D_{osc,ampl} of the oscillation with which the length-averaged outer diameter D of the massaged portion of the teat shaft oscillates about the mean value D_{osc,mean} may obey the inequality D_{osc,ampl}<0.10·Dₙ; in a preferred embodiment, D_{osc,ampl} may obey the inequality D_{osc,ampl}<0.05·Dₙ. The oscillation amplitude may thus be relatively small and typically be on the order of 1-2 mm.

A surprising advantage of the method according to the present invention is that it enables a greater-than-conventional peak milk flow rate (g/min) at a greater-than-conventional milking vacuum pressure. Here the word ‘milking vacuum pressure’ is used in its respective meanings, so as to say that the milking vacuum pressure (in its appropriate above-defined meaning) in the present method is greater than the milking vacuum pressure (in its conventional meaning) in conventional pulsation-based milking methods; hence, in the present method the teat-end is exposed to a lower than conventional vacuum level. In one embodiment of the presently disclosed method, the milking vacuum may have a mean pressure in the range of −33±4 kPa, and more preferably in the range of −35±2 kPa, relative to atmospheric pressure, compared to a typical conventional milking vacuum pressure about −42 kPa relative to atmospheric pressure. As a result of the relatively low milking vacuum level the longitudinal elongation of a teat that occurs during milking is significantly reduced. In addition, the squeezing of the lower portion of the teat due to the liner collapses is eliminated, as mentioned. The combination of these aspects may lead to a lower risk of tissue damage, mastitis and teat end hyperkeratosis. Contrary to scientific research related to conventional milking methods, however, the relatively low milking vacuum as applied in the presently disclosed method has been observed to correspond not to a decrease but to an increase in the peak milk flow rate (relative to conventional methods).

Without wishing to be bound by theory, it is conjectured that this finding may in part be explained by the fact that the aforementioned smaller longitudinal elongation of the teat diminishes the diameter reduction of the teat canal that naturally accompanies the elongation of the teat, and that inhibits the outflow of milk. In this regard, it is anticipated that application of conventional milking vacuum levels in the presently disclosed method might increase the milk flow rate further, but at the heavy cost of higher mechanical loads on the teat. In addition, the continuous variable radial compression is hypothesized to provide for gentle yet more intense (oxytocin release triggering) sensory stimulation of the teat, while the continuous rather than discontinuous application of the milking vacuum prevents the abrupt periodic pinching off of the teat end/teat canal, which is believed to have a negative effect on the peak milk flow rate. —Some comparative experimental results are discussed infra.

With a view to existing prior art, it should be observed that the presently disclosed milking method is different from those disclosed by US 2011/0,107,971-A1 (Petterson).

US '971 discloses two milking methods, both of which make use of teat cup, including both a teat cup liner and a teat cup shell, whose teat cup liner is arranged to support and fit tightly to a teat of a lactating animal throughout a milking session. The teat cup liner is configured to apply a ‘uniform pressure’ to the teat throughout the milking session, so that the process of milking is more comfortable to the animal. In a first of the two methods disclosed by US '971, the uniform pressure is varied with time. That is, a (pulsation) chamber of the teat cup disposed in between the shell and the liner is subjected to a pulsating vacuum by means of a pulsator that alternates between substmospheric pressure and atmospheric pressure, so as to cause the cyclical collapse of the liner towards the teat contained therein (e.g. para. 46). In a second of the two methods, the uniform pressure applied to the teat is not varied with time. That is, the pressure in the aforementioned chamber is maintained at a substantially constant level.

Hence, the first method disclosed by US '971 cannot include the above-described aspect (i) because a collapsing liner necessarily interferes with the application of a continuous, substantially constant milking vacuum. In the light of the collapsing liner, the presence of aspect (ii) in the method of US '971 also appears doubtful: an elastic liner that, at least below the teat end, deforms non-axisymmetrically is sure to distort the axi-symmetry of the teat contained therein above the region of collapse, in particular when it encloses the teat tightly around its circumference. The second method of US '971 would appear to include aspect (i) as it does away with collapsing the liner, but as a result of the non-pulsating vacuum in the pressure chamber it lacks aspect (iii). This means that the method does not involve (oxytocin release triggering) sensory stimulation of the teat.

In an embodiment of the method, a time interval during which D<D_{osc,mean} defines a compression phase, a time interval during which D>D_{osc,mean} defines a stretch phase, and each milking cycle or oscillation period includes a stretch phase and a subsequent compression phase wherein the compression phase is of a shorter duration than the stretch phase.

During each milking cycle, the massaged portion of the shaft is first radially stretched or widened, and then radially compressed or narrowed relative to its already compressed state (wherein D=D_{osc,mean}). During the stretch phase, the outer diameter D of the massaged portion of the teat shaft is temporarily enlarged and the teat canal in the teat end is open. This allows the pressure differential across the teat canal, i.e. the difference between the pressure within the teat/udder and the pressure in the barrel just below the teat end, to force the milk outward. During the compression phase, the diameter D of the massaged portion of the teat shaft is temporarily reduced. Although the compression phase does serve to provide some temporary relief to the teat, the teat canal does not necessarily close, and milk extraction from the teat does not need to come to a complete halt. This may be because the lower, distal end of the teat, e.g. the most distal 10-20% thereof need not have direct contact with the liner; hence, a negative pressure may act on the distal end of the teat, and allow for a continuous opening of the teat canal, thus for milk flow. A running stream of milk may thus be slowed down only slightly and temporarily.

In a further embodiment of the method, the compression phase accounts for 37±7% of a single milking cycle or oscillation period, and the stretch phase accounts for the remaining 63±7%.

The presently disclosed method of milking may be used in combination with different oscillation patterns, i.e. the ratio between the duration of the stretch phase and the duration of the compression phase, such as 60:40 and 67:33. The oscillation rate may typically range from 40-70 oscillations or milking cycles per minute.

In another embodiment of the presently disclosed milking method an alternative method of sensory stimulation of the teat may be used. In this alternative method, each milking cycle or oscillation period may include a stretch phase, i.e. a time interval during which D>D_{osc,mean}, and a compression phase during which the teat is not simply statically compressed (as described above), but instead subjected to brief, successive compressions or compressive vibrations in each of which D is brought to <D_{osc,mean}. The compressive vibrations may have a frequency in the range of 60-300, e.g. about 200, compressions per minute. In this alternative method too, the compression phase may be of a shorter duration than the stretch phase. For instance, the compression phase, which may last about 0.3-2 seconds, e.g. 1 second, may be followed by a stretch phase of about 0.7-9 seconds, e.g. 4 seconds.

According to an elaboration of the present invention, the method further comprises providing a teat cup. The teat cup includes a shell, configured for receiving a liner, and a flexible, elastic liner that is at least partly received within the shell. The liner comprises a liner head, a barrel and a milk tube. The liner head and the milk tube are disposed at opposite ends of the barrel. The liner head comprises an opening via which a teat is receivable in the barrel, and the milk tube comprises a tube canal through which milk extracted from a teat in the barrel can be discharged to outside of the teat cup. The method also comprises inserting the teat into the barrel of the liner such that at least the aforementioned portion of the shaft is received therein, and repeatedly alternatingly increasing and decreasing an extent of radial compression of said portion of the shaft of the teat by varying an inner diameter of a portion of the barrel that circumferentially encloses said portion of the shaft.

The portion of the barrel that circumferentially encloses the portion of the shaft that is to be massaged has an average inner diameter d, which in a relaxed state of the liner (i.e. a state in which the liner is not influenced by any external forces) equals dₙ. In one embodiment, the barrel portion has a (relaxed) inner diameter that is smaller than the outer diameter of the teat shaft portion in its pre-milking state, i.e. dₙ<Dₙ. In a preferred embodiment, dₙ<0.9·Dₙ, and more preferably dₙ<0.85·Dₙ. These conditions ensure that the liner, in the absence of any external forces, will clamp the teat shaft and attempt to force it into a state of radial compression, thereby reducing the chance of liner slip during milking.

As mentioned above, the method according to the present invention does not employ a periodically collapsing liner to massage the teat and to relief it from the milking vacuum. Since the liner does not need to close below the teat end, it may be shorter than conventional liners in relation to a teat to be milked, and thus be cheaper to manufacture due to reduced material costs.

Furthermore, a shorter liner may be used with a shorter teat cup shell; hence the overall length and mass of a single teat cup, and hence the mass of a milking cluster including several teat cups, may be lowered, reducing the load on an animal's udder and the risk of teat cup slips. In one embodiment of the method, the length of the barrel of the liner is no more than 25 mm, and preferably no more than 20 mm, greater than a length of the inserted teat.

The provided teat cup may define a pressure chamber between the shell and the liner, which pressure chamber may circumferentially enclose the teat shaft portion received in the barrel. In one embodiment, milking the teat by repeatedly alternatingly increasing and decreasing an extent of radial compression of said portion of the shaft involves oscillating a pressure P_{prch} inside the pressure chamber about the milking vacuum pressure P_{mvac}. P_{prch} may oscillate about P_{mvac} with an amplitude P_{prch,ampl}<10 kPa, so as to effect relatively small and well-controlled changes in the extent of radial compression of the teat.

A second aspect of the present invention is directed to a teat cup liner for milking a cow, a sheep or a goat. The liner comprising a liner head, a barrel and a milk tube. The liner head and the milk tube are disposed at opposite ends of the barrel. The liner head comprises an opening via which a teat is receivable in the barrel, and the milk tube comprises a tube canal through which milk extracted from a teat in the barrel can be discharged to outside of the teat cup. In a relaxed state, the liner has a length and an average inner diameter which are selected in dependence of the animal species to be milked according to the following table:

| lactating animal | | average inner diameter |
|---|---|---|
| species | length of barrel | of barrel |
| cow | <100 mm | 20 mm ± 15% |
| sheep, goat | <100 mm | 17 mm ± 15% |

In a preferred embodiment of the teat cup liner, the length and average inner diameter are selected in dependence of the lactating animal species to be milked according to the following table:

| lactating animal | | average inner diameter |
|---|---|---|
| species | length of barrel | of barrel |
| cow | <95 mm | 20 mm ± 10% |
| sheep, goat | <95 mm | 17 mm ± 10% |

The inner diameter of the barrel of the teat cup liner according to the second aspect of the invention may be substantially uniform over the length of the barrel. That is, the inner diameter may not vary by more than 5% of the value of the average inner diameter of the barrel over the length of the barrel.

These and other features and advantages of the invention will be more fully understood from the following detailed description of certain embodiments of the invention, taken together with the accompanying drawings, which are meant to illustrate and not to limit the invention.

### BRIEF DESCRIPTION OF THE DRAWINGS

FIG. 1 is a schematic cross-sectional side view of two known teat cups, and illustrates their use during conventional pulsation milking wherein the teats of an udder are alternatingly subjected to a milking phase (left teat cup) and a rest phase (right teat cup);

FIG. 2 is a schematic cross-sectional side view of a teat cup according to the present invention;

FIG. 3 schematically illustrates, in a cross-sectional side view, the insertion of a teat into the teat cup of FIG. 2;

FIGS. 4 and 5 schematically illustrate the compression phase (FIG. 4) and stretch phase (FIG. 5) of a milking cycle; and

FIG. 6 is a diagram schematically illustrating how during the milking of a teat according to the presently disclosed method, the teat shaft is kept under continuous radial compression while the extent of that radial compression is varied.

### DETAILED DESCRIPTION

Before describing the method of milking an animal and the construction of the teat cup according to the present invention, attention is invited to a conventional method of milking employing an exemplary known teat cup.

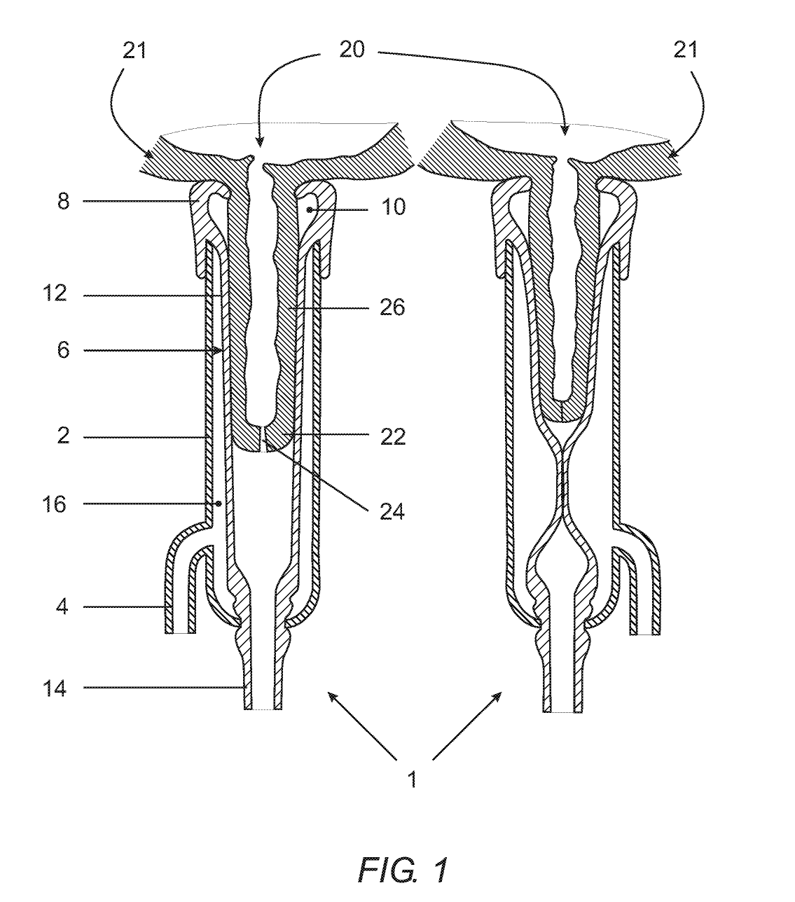

FIG. 1 schematically illustrates two specimens of a known teat cup 1, attached to respective teats 20 of an udder 21. The shown teat cups 1 are identical in construction, but are depicted in different phases of the milking process. The construction of the depicted known teat cup 1 will be elucidated first. Next, its operation during a conventional milking cycle will be explained briefly, wherein special attention will be paid to the drawbacks associated with its use.

A teat cup 1 generally comprises two parts: a rigid outer shell 2, and a flexible liner 6.

The teat cup shell 2 is shaped to suit the shape/design of the liner 6, and primarily serves to give the teat cup 1 a good degree of rigidity. It is preferably easy to handle during milking, and constructed of a material that is capable of withstanding rough treatment, such as dropping to the floor and kicking of animals. Accordingly, teat cup shells 2 may typically be manufactured from stainless steel, although hard plastic variants have appeared on the market as well, reflecting attempts to lower their weight. Often, the teat cup shell 2 is little more than a substantially cylinder jacket-shaped container, having an opening at a top end for insertion of a liner 6, and a passage at a lower end for a milk tube 14 of the liner 6. Once a liner 6 is inserted into the teat cup shell 2, a pressure or pulsation chamber 16 is defined between them. The pressure chamber 16 typically encloses the entire barrel portion 12 of the liner 6. To allow a pressure tube of an external pressure source, such as a pulsator, to be conveniently connected to the pressure chamber 16, the shell 2 may include a short pressure or pulse tube 4.

A liner 6 is a flexible, typically elastic sleeve comprising a liner head or mouthpiece 8, a barrel 12 and an integral or separate short milk tube 14. It is the only part of the teat cup 1, and of an entire milking machine for that matter, that comes into contact with an animal's teats 20, and its design is therefore key to the process of milking animals. The mouthpiece 8 serves to provide an airtight connection at the top end of the teat cup 1, so that a milking vacuum can be maintained within the barrel 12 and the milk tube 14 during operation. To assist in holding the teat cup 1 mounted on a teat 20, the mouthpiece may comprise a mouthpiece chamber 10, whose working will be clarified below. When connected to a vacuum line, the milk tube 14 allows a milking vacuum to be applied to the interior of the barrel 12, and ensures that any milk ejected by a teat 20 can be carried off. As a whole, a liner 6 may be constructed by means of injection molding from a variety of materials, including natural and synthetic, e.g. nitrile, or silicone rubbers. Since natural rubber tends to deteriorate relatively fast due to the inevitable contact with milk, a liner 6 made of synthetic rubber or a mixture of synthetic and natural rubbers may be preferred.

In practice, several teat cups 1 are usually combined in a cluster that, besides the teat cups 1, comprises a claw, a long milk tube and a long pressure tube. The claw connects the (short) pressure tubes and the (short) milk tubes of the teat cups to the long pressure tube and the long milk tube, respectively, allowing milking to take place at a distance from pressure sources/vacuum equipment (e.g. pulsators and vacuum sources) and milk reservoirs. As claws, clusters and milking machines as such are known in the art, they will not be elaborated upon here any further.

Upon milking a milking vacuum is applied to the short milk tube 14, and hence to the interior of the barrel 12. As soon as a teat 20 that is to be milked enters the liner 6 via the mouthpiece 8, the teat is sucked and stretched into the liner. It is not uncommon for the distal 10% of the teat 20 to reach about 110-150% of its pre-milking length. Research has revealed that this is detrimental to the condition of the teat, in particular when the stress is sustained for a complete milking event (lasting several minutes). The longitudinal strain in the teat may, for example, result in or increase the risk of tissue damage and teat end hyperkeratosis. Once the teat 20 occupies the upper part of the barrel 12, the vacuum induced in the interior of the liner 6, including the mouthpiece chamber 10, causes the external atmospheric pressure to squeeze the mouthpiece 8 against the shaft 26 of the teat 20. This action provides for an airtight seal between the mouthpiece 8 and the teat 20, and at the same time for sufficient friction to hold the liner 6 and thus the teat cup 1 in place.

Then, a pulsating vacuum is applied to the short pressure tube 4, and thus to the pressure chamber 16. Broadly speaking, a single pulsation cycle may comprise two alternating phases: a milk phase, and a rest phase. During the milk phase, shown for the left teat cup 1 in FIG. 1, a vacuum applied to the pressure chamber 16 prevents the barrel 12 from collapsing under the influence of the milking vacuum that prevails in the interior of the liner 6. The external orifice of the teat canal 24 in teat end 22 is therefore subjected to a negative pressure (milking vacuum) that effectively draws milk from the teat 20. During the subsequent rest phase, shown for the right teat cup 1 in FIG. 1, the vacuum inside the pressure chamber 16 is momentarily turned off, and air is allowed to flow in. As the negative pressure inside the pressure chamber 16 quickly rises to an atmospheric level, the barrel 12 collapses around the teat shaft 26 and teat end 22. Besides massaging the teat 20 and promoting the circulation of blood and lymph, the sudden collapse of the barrel 12 may also induce a detrimental backflow of milk into the teat canal 24. Since milk that has (almost) left the teat canal 24 may have been in contact with bacteria, e.g. present on the teat end 22 near the external orifice of the teat canal 24, a backflow may help these organisms to penetrate (deeper) into the teat canal, and even into the teat cistern. Lesions and damage to the teat 20, for example caused by the aforementioned stretching thereof, provide sites for the bacteria to lodge and may prevent them from being flushed out. Inside the teat 20, lodged bacteria may give rise to inflammations, such as mastitis.

Another adverse effect associated with known teat cups 1 may occur at the end of a milking job. When the teat and udder cisterns are close to depletion, the liner 6 sometimes crawls up along the teat 20 to obstruct the milk flow from the udder cistern to the teat cistern. This phenomenon may lead to incomplete milk removal and in the long run to reduced milk production.

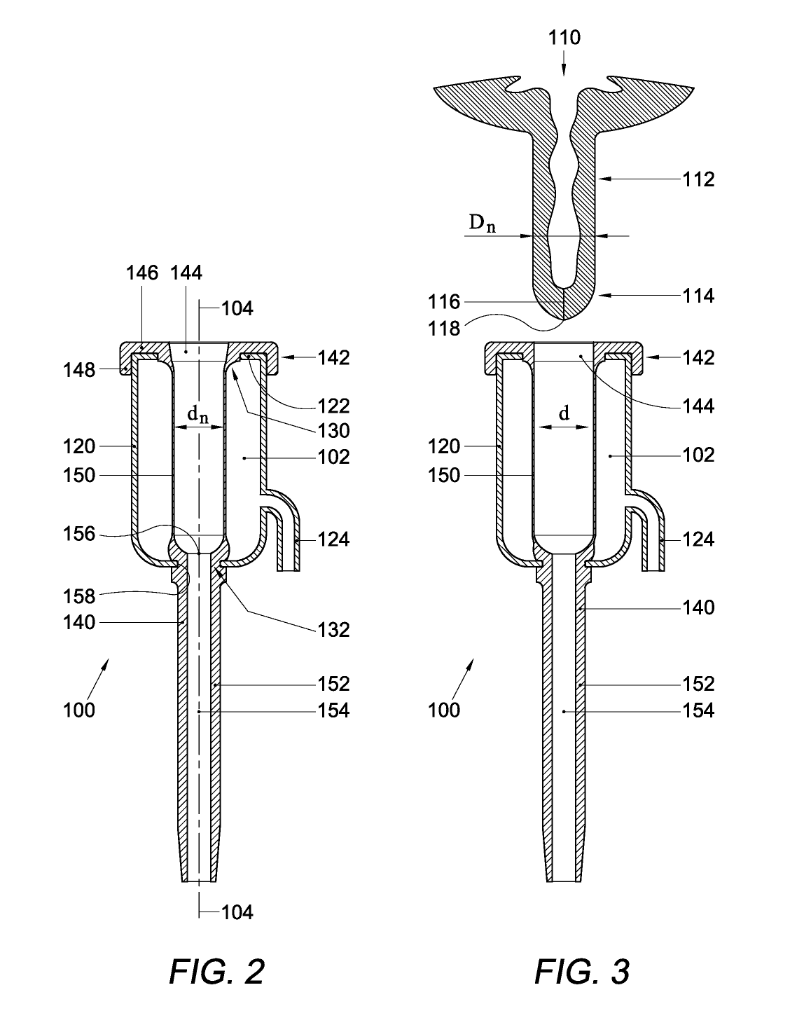

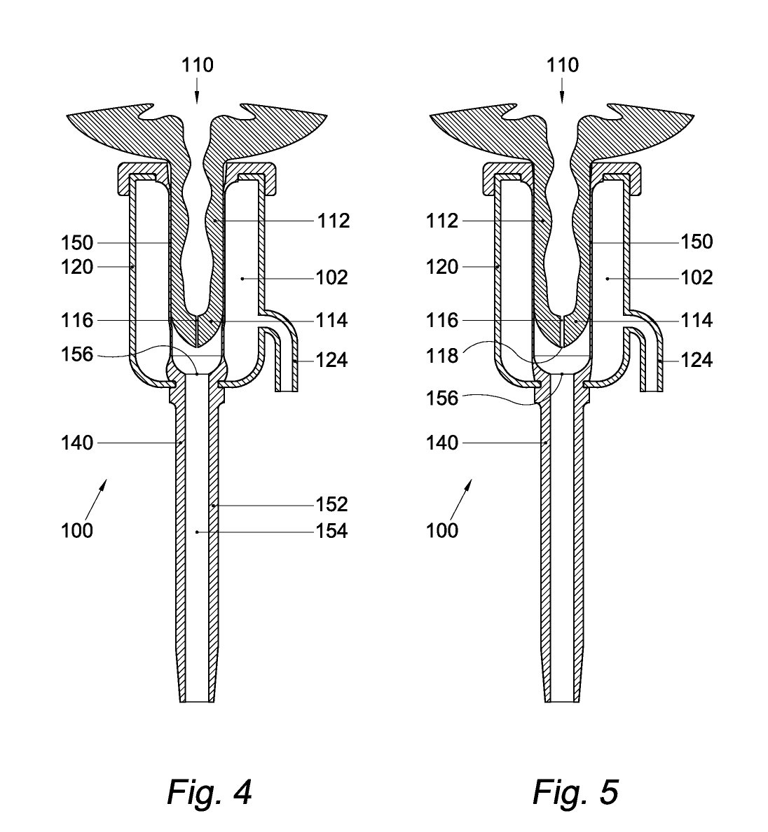

Turning now to the construction and operation of a teat cup according to the present invention. FIG. 2 shows a schematic cross-sectional profile of an exemplary embodiment of such a teat cup 100, including a teat cup shell 120 and a liner 140. FIG. 3 illustrates the process of insertion of a teat 110 into the teat cup 100, whereas FIGS. 4-5 together illustrate the use of the teat cup 100 in the milking method according to the present invention.

Referring now to FIG. 2. A teat cup 100 may comprise a teat cup shell 120. Apart from a short pressure tube 124, the shell 120 may be axially symmetric with respect to a longitudinal axis 104, and be generally cylinder jacket-shaped. In other embodiments, however, the shell 120 may have a different form, for example prismatic, and possess a lesser degree of rotational symmetry. At one end, the teat cup shell 120 may be fitted with an entrance opening 130 through which a liner 140 may be inserted into the interior of the shell. At another end, typically opposite the entrance opening 130, the shell 120 may be fitted with a second opening 132 that provides for an outlet for the milk tube 152 of the liner 140. The diameter of the entrance opening 130 may typically be somewhat larger than that of the milk tube outlet 132, but need not be.

Around the entrance opening 130, the shell 120 may be provided with an inwardly extending flange 122, which may serve as a support for the liner head 142 of the liner 140. The flange 122 and the liner head 142 may together form an airtight seal that, in an assembled state of the teat cup 100, seals off the pressure chamber 102. The flange 122 may take different shapes in different embodiments of the teat cup shell 120, and even be omitted if desired. The assembled teat cup 100 may define a pressure chamber 102 between the shell 120 and the liner 140. In order to provide a convenient joint for a pressure hose via which the pressure chamber 102 may be pressurized, the teat cup may be provided with a short pressure tube 124. The short pressure tube 124 may extend substantially in the direction of the longitudinal axis 104 of the teat cup shell 120, so as not to form possibly hazardous or vulnerable projections from the general shape of the teat cup 100.

The teat cup shell 120 may be manufactured from any suitable material, such as, for example, stainless steel or a hard plastic. The length of the teat cup shell 120, measured from the entrance opening 130 to the milk tube outlet 132, may substantially correspond to, and generally be only about 1-2 cm greater than, the length of the barrel 150 of the liner 140. Since the present invention makes use of a relatively short liner barrel 150, the length of the teat cup shell 120 may be similarly small to help minimize the weight of the teat cup 100. A length in the range of 9-13 cm, e.g. 11 cm, may suffice for most applications. The diameter of the teat cup may be on the order of 4.5-5 cm.

The teat cup 100 may further include a liner 140 that is configured to be received within the teat cup shell 120, as shown in FIG. 2. The liner 140 may be axisymmetric with respect to a longitudinal axis 104, which—in the depicted assembled state of the teat cup 100—coincides with the longitudinal axis 104 of the teat cup shell 120. The liner 140 may comprise a liner head 142, a barrel 150 and a milk tube 152.

The liner head 142, which forms an end part of the liner 140, may comprise an opening 144 that gives access to the barrel 150. The liner head 142 may include a mouthpiece chamber, which is not shown for the exemplary embodiment of FIG. 2 et seq., but which was described with reference to FIG. 1. In the exemplary teat cup 100, however, a mouth piece chamber for fixating the teat cup relative to a teat is practically superfluous as a result of the continuous state of radial compression in which an inserted teat is kept during milking (causing static friction that prevents the liner 140 from slipping relative to the teat), and the significantly reduced size and weight of the teat cup 100. The liner head 142 may further include a bumper portion 146, which in an assembled state of the teat cup 100 may abut the flange 122 of the teat cup shell 120, and a collar 148, which may clamp around an edge of teat cup shell 120 to secure the liner 140 thereto.

The barrel 150 may connect the liner head 142 to the milk tube 152. In an assembled state of the teat cup 100, substantially the entire barrel 150, or alternatively only a portion thereof, may be enclosed by the pressure chamber 102. The barrel 150 may be substantially cylindrical, as depicted in FIG. 2, such that, in a relaxed state of the liner 140, it has a uniform inner diameter dₙ. In an alternative embodiment, the barrel 150 of the liner may have a slight taper, giving it an average inner diameter dₙ. At any rate, the average inner diameter dₙ may be smaller than the (average) outer diameter Dₙ of the shaft of a teat that is to be milked. This means that a liner 140 for milking cows may typically have an inner diameter dₙ in the range 20 mm±15%, while a liner for milking coats and sheep may typically have an inner diameter dₙ in the range 17 mm±15%. The length of the barrel 150 may typically measure less than 100 mm, which is significantly shorter than the typical barrel length of known liners for pulsation milking.

The milk tube 152 connects to the barrel 150 of the liner at the lower end thereof, such that the interior of the barrel 150 is in fluid connection with a tube canal 154 of the milk tube 152 via a mouth 156 of the tube canal 154 at the bottom of the barrel. The milk tube may have an exterior surface that is provided with one or more ridges/indentations 158, which may be configured for cooperation with an (external surface of an) edge of milk tube outlet 132 of the teat cup shell 120, so as to enable an airtight seal between the shell and the milk tube.

The liner 140 may be made of an elastic material, e.g. rubber or silicone, and may be economically manufactured in one piece through for example injection molding.

Now that the construction of the exemplary teat cup 100 according to the present invention has been elucidated, its operation will be clarified with reference to FIGS. 3-6.

Referring first to FIG. 3. Prior to milking, at least a longitudinal portion of a shaft 112 of a teat 110 must be inserted into the barrel 150 of the liner 140. The teat shaft 112 may have a natural outer diameter Dₙ, while the barrel 150 of the liner 140, in its relaxed state, may have a substantially uniform inner diameter dₙ, such that dₙ<Dₙ. Dₙ may, for example, equal 25 mm, while dₙ may equal 20 mm. To facilitate insertion of the teat shaft 112 into the barrel 150, the barrel may be widened. Although a milking vacuum may typically be applied to the milk tube 154 already at this stage, the pressure inside the barrel 150 may still be substantially atmospheric due to fact that the teat 110 does not yet close off the opening 144 in the liner head 142. Hence, the barrel 150 may be widened by lowering the pressure in the pressure chamber 102 to below atmospheric pressure, e.g. to about the pressure of the milking vacuum. The inner diameter d of the barrel need not be increased to exceed Dₙ, but may preferably approximate Dₙ to facilitate smooth insertion to the teat 110 under the influence of the milking vacuum. For instance, where Dₙ equals 25 mm, d may be increased to about 24 mm. When the teat end 114 is then brought into abutment with the edge of the opening 144 in the liner head 142, it will substantially close off the upper end of the barrel 150, causing the teat 110 to be slidingly sucked into the barrel 150 as the pressure therein drops to about the milking vacuum. Once the teat 110 is received inside the barrel 150, the barrel may attempt to regain its relaxed shape and thereby radially compress the teat shaft 112 into a compressed state that ensures a generally air tight, slip free attachment of the liner 140 to the teat 110.

When the teat cup 100 has been attached to the teat 110 milking may commence. Milking the teat 110 may include massaging at least a portion of the teat shaft 112 by repeatedly alternatingly increasing and decreasing a diameter thereof, preferably such that the axi-symmetric shape of both the teat 110 and the barrel 150 are preserved. At the same time the milking vacuum may be applied continuously to the teat end 114. The massaging of the teat 110 is considered necessary to stimulate the animal to release milk. In a preferred embodiment, as illustrated here, the massaged portion of the teat shaft 112 may be kept under continuous radial compression relative to its natural pre-milking state. The extent of radial compression of the teat shaft 112 may be increased relative to the extent of radial compression in the above-defined compressed state by increasing the pressure inside the pressure chamber 102 to above the pressure of the milking vacuum. Similarly, the extent of radial compression may be decreased relative to the extent of radial compression in the above-defined compressed state by decreasing the pressure inside the pressure chamber 102 to below the pressure of the milking vacuum. Hence, to repeatedly alternatingly increase and decrease an extent of radial compression of the teat shaft, the pressure inside the pressure chamber 102 may be oscillated or varied about the milking vacuum P_{mvac}, such that the average outer teat shaft diameter D correspondingly oscillates about a mean value D_{osc,mean}. A time interval during which D<D_{osc,mean} defines a compression phase, while a time interval during which D>D_{osc,mean} defines a stretch phase. Each oscillation or milking cycle includes precisely one stretch phase and precisely one subsequent compression phase. The compression phase may preferably be of shorter duration than the stretch phase. In case of an oscillation rate of 1 Hz (i.e. one milking cycle per second), the compression phase may, for example, last 400 ms, while the stretch phase may last 600 ms.

FIGS. 4 and 5 schematically illustrate the compression phase (FIG. 4) and stretch phase (FIG. 5) of a milking cycle.

In the compression phase of FIG. 4, the pressure P_{prch} inside the pressure chamber 102 exceeds the milking vacuum pressure P_{mvac}, preferably by a few kPa, e.g. by about 2 kPa. The overpressure in the pressure chamber 102 forces the barrel wall inwards and so radially loads the teat shaft 112. As a result the already compressed teat shaft 112 may be compressed further, for example to an outer diameter D of about 20.5 mm. Below the teat end 114 the barrel 150 may flex inwards a little further, for example to its relaxed inner diameter dₙ of about 20 mm. Care should be taken, however, to ensure that the pressure differential P_{prch}−P_{mvac} does not cause the barrel 150 to collapse and close below the teat end 114, such that the teat end 114 remains exposed to the milking vacuum, and no excessive clamping stress is exerted on the teat end 114. The absence of such excessive clamping stress reduces the risk of tissue damage and teat end hyperkeratosis, both of which occur commonly in conventional milking. In addition, the lack of excessive clamping stress allows milk to be extracted from the teat 110 (implying a slightly open teat canal 116) even during the compression phase in case the internal pressure in the teat shaft/udder is sufficiently large.

In the stretch phase of FIG. 5, the pressure P_{prch} inside the pressure chamber is reduced to below the milking vacuum pressure P_{mvac}, preferably by a few kPa, e.g. by about 7-8 kPa. Indeed, the pressure amplitude during the stretch phase may be greater than during the compression phase. The underpressure in the pressure chamber 102 enables the internal pressure in the teat shaft 112 (where the teat shaft is present) and the milking vacuum (below the teat end 114) to force the barrel wall radially outwards. Consequently the outer diameter D of the teat 110 may grow to a value below Dₙ, for example to about 22 mm, so as to widen the teat canal and enable the extraction of milk under the influence of the milking vacuum.

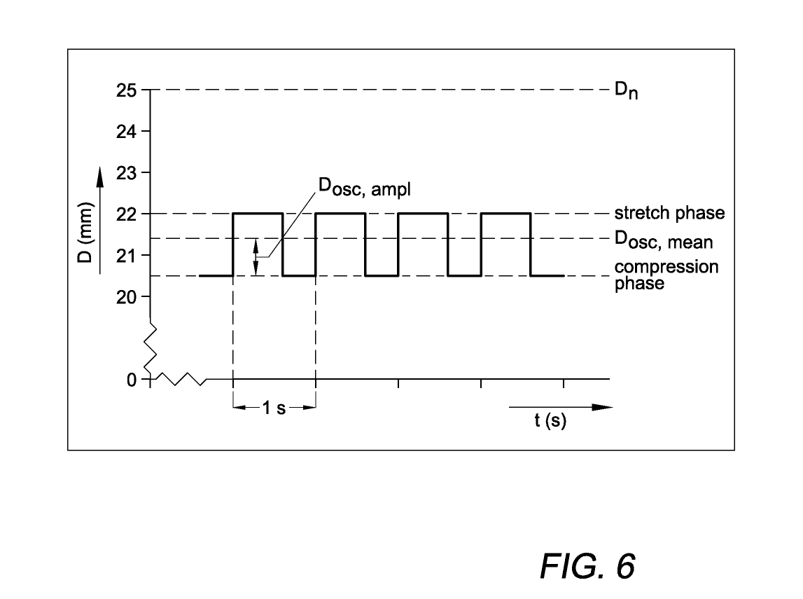

FIG. 6 schematically represents the variation of the outer diameter D of the teat shaft 112 as a function of time during the exemplary milking process outlined above with reference to FIGS. 4 and 5. D can be seen to oscillate about a time-averaged outer diameter value D_{osc,mean} that lies well below the natural pre-milking diameter Dₙ of the teat shaft 112 of about 25 mm. Each oscillation or milking cycle has a duration of about 1 second, and includes both a compression phase and a stretch phase. During a compression phase, the outer diameter D of the teat shaft 112 is decreased to about 20.5 mm, while during a stretch phase, the outer diameter D rises to about 22 mm. The oscillation pattern is 60:40, which brings the value of D_{osc,mean} in this example to (0.6*22+0.4*20.5=) 21.4 mm.

The method and liner according to the present invention have been tested. In a brief experiment, five cows where first milked several times using conventional liners and standard milking parameters (ST), and subsequently in accordance with the presently disclosed method using the presently disclosed liner and four sets of adapted milking parameters (NT1, NT2, NT3, NT4). Table 1 lists the parameter values for the various parameter sets.

TABLE 1
Milking parameters.

| | | Pressure chamber | |
|---|---|---|---|
| | | pressure during | |
| | Milking | compression phase | Oscillation pattern |
| | vacuum pressure | and stretch phase | (stretch |
| | relative to | relative to | phase:compression |
| Parameter | atmospheric | atmospheric | phase) |
| set | pressure (kPa) | pressure (kPa) | (1 oscillation = 1 s) |
| ST1 | −40 | −40/0 | 60:40 |
| NT1 | −30 | −38/−28 | 60:40 |
| NT2 | −30 | −46/−26 | 60:40 |
| NT3 | −35 | −43/−33 | 60:40 |
| NT4 | −35 | −51/−31 | 60:40 |

For clarity, it is noted that the milking vacuum pressure listed for parameter set ST1 relates to the teat-end vacuum during the b-phase (i.e. the liner open or milking phase) of the pulsation cycle during which the liner opens and closes, and not to the teat-end vacuum measured over an integer number of complete milking cycles.

Table 2 lists the peak milk flow rate, both in absolute terms (g/min) and relative to peak milk flow rate obtained in the conventional series (ST1). The listed ‘peak milk flow rate’ was determined over an interval of 30 s, and then converted to grams per minute.

TABLE 2
Peak milk flow rates for different milking parameter sets.

| | | % of peak milk flow rate |
|---|---|---|
| Parameter set | Peak milk flow rate (g/min) | found for ST1 |
| ST1 | 1141 | 100 |
| NT1 | 1109 | 97 |
| NT2 | 1103 | 97 |
| NT3 | 1289 | 113 |
| NT4 | 1309 | 115 |

The results in Table 2 illustrate that for the parameter sets NT1 and NT2, the peak milk flow rate dropped with a mere 3% relative to that found for conventional milking, despite the 25% decrease in milking vacuum.

For parameter sets NT3 and NT4 employing a milking vacuum that was 12.5% less than that used for ST1, the peak milk flow rate increased by about 14% on average. The different pressure chamber pressure settings did not appear to produce a clear effect when used with the same milking vacuum level (NT1 vs. NT2, and NT3 vs. NT4).

Although illustrative embodiments of the present invention have been described above, in part with reference to the accompanying drawings, it is to be understood that the invention is not limited to these embodiments. Variations to the disclosed embodiments can be understood and effected by those skilled in the art in practicing the claimed invention, from a study of the drawings, the disclosure, and the appended claims. Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, it is noted that particular features, structures, or characteristics of one or more embodiments may be combined in any suitable manner to form new, not explicitly described embodiments.

### LIST OF ELEMENTS AND SYMBOLS

### Prior Art

1 teat cup
2 teat cup shell
4 pressure or pulse tube
6 teat cup liner
8 liner head/mouthpiece
10 mouthpiece chamber
12 barrel
14 (short) milk tube
16 pressure or pulsation chamber
20 teat
21 udder
22 teat end
24 teat canal
26 teat shaft

### Invention

100 teat cup
102 pressure chamber
104 longitudinal axis
110 teat
112 teat shaft
114 teat end
116 teat canal
118 external orifice of teat canal
120 teat cup shell
122 flange
124 short pressure tube
130 entrance opening
132 milk tube outlet
140 liner
142 liner head
144 liner head opening
146 bumper
148 collar of liner head
150 barrel
152 milk tube
154 tube canal of milk tube
156 mouth of tube canal
158 indentation in milk tube exterior

1. Method of mechanically milking a lactating animal, such as a cow, a goat and a sheep, comprising:
providing an animal having at least one teat, said teat comprising an elongate shaft and a teat end at an end of said shaft, said teat end comprising a teat canal having an external orifice;
milking the teat by repeatedly alternatingly increasing and decreasing a diameter (D) of at least a longitudinal portion of its shaft, while maintaining a substantially axi-symmetric shape of said portion of the shaft, and while continuously applying a milking vacuum to the teat end so as to extract milk from the external orifice of the teat canal.

2. The method according to claim 1, further comprising:
before starting the milking, radially compressing the longitudinal portion of the shaft of the teat from a natural pre-milking state to a compressed state, and, thereafter, milking the teat while keeping the diameter (D) of the longitudinal portion of the shaft below that (Dₙ) of its natural pre-milking state.

3. The method according to claim 1, wherein said longitudinal portion of the shaft of the teat has an average outer diameter, which equals diameter of the teat in a natural pre-milking state (Dₙ),
and wherein repeatedly alternatingly increasing and decreasing the diameter of said portion of the shaft includes oscillating the average outer diameter of said portion about a mean value D_{osc,mean}<0.90·Dₙ.

4. The method according to claim 3, wherein repeatedly alternatingly increasing and decreasing the diameter of said portion of the shaft includes oscillating the average outer diameter of said portion about a mean value D_{osc,mean}<0.875·Dₙ.

5. The method according to claim 3, wherein the average outer diameter D of said portion oscillates about the mean value D_{osc,mean} with an amplitude D_{osc,ampl}<0.10·Dₙ.

6. The method according to claim 3, wherein a time interval during which D<D_{osc,mean} defines a compression phase, wherein a time interval during which D>D_{osc,mean} defines a stretch phase, and wherein each oscillation period includes a stretch phase and a subsequent compression phase wherein the compression phase is of a shorter duration than the stretch phase.

7. The method according to claim 6, wherein the compression phase accounts for 37±7% of a single oscillation period, and wherein the stretch phase accounts for the remaining 63±7%.

8. The method according to claim 1, wherein the milking vacuum has a mean pressure in the range of −33±4 kPa relative to atmospheric pressure.

9. The method according to claim 1, wherein, during an oscillation, a momentary milking vacuum pressure deviates from the milking vacuum pressure's mean value by a certain maximum absolute value,
and wherein an average of said maximum absolute values over a plurality of oscillations during milking does not exceed a fourth of the milking vacuum's absolute mean value relative to atmospheric pressure.

10. The method according to claim 1, wherein said longitudinal portion of the shaft of the teat covers at least 75% of a length of the teat, said teat length being measured from a base of the shaft to the external orifice of the teat canal.

11. The method according to claim 1, further comprising:
providing a teat cup, including:
a shell, configured for receiving a liner;
a flexible liner, at least partly received within the shell, said liner comprising a liner head, an elongate substantially axi-symmetric barrel and a milk tube, the liner head and the milk tube being disposed at opposite ends of the barrel, said liner head comprising an opening via which a teat is receivable in the barrel, and said milk tube comprising a tube canal through which milk extracted from a teat in the barrel can be discharged to outside of the teat cup;
inserting the teat into the barrel of the liner such that at least said longitudinal portion of the shaft is received therein; and
repeatedly alternatingly increasing and decreasing a diameter (D) of the longitudinal portion of the shaft of the teat by varying an inner diameter (d) of a portion of the barrel that circumferentially encloses said portion of the shaft, while maintaining the substantially axi-symmetric shape of the barrel of the liner.

12. The method according to claim 11, wherein said portion of the barrel has a length-averaged inner diameter d, which in a relaxed state of the liner equals dₙ, and wherein dₙ<Dₙ.

13. The method according to claim 12, wherein dₙ<0.9·Dₙ.

14. The method according to claim 11, wherein a length of the barrel of the liner is no more than 25 mm greater than a length of the inserted teat.

15. The method according to claim 11, wherein the liner does not collapse while its inner diameter (d) is varied.

16. The method according to claim 11, wherein, in the provided teat cup (100), a pressure chamber (102) exists between the shell (120) and the liner (140), which pressure chamber circumferentially encloses said portion of the shaft (112) received in the barrel, and
wherein repeatedly alternatingly increasing and decreasing a diameter (D) of the longitudinal portion of the shaft (112) of the teat (110) involves oscillating a pressure P_{prch} inside the pressure chamber about the milking vacuum pressure P_{mvac}.

17. The method according to claim 16, wherein P_{prch} oscillates about P_{mvac} with an amplitude P_{prch,ampl}<10 kPa.

18. A teat cup liner for milking a cow, a sheep or a goat, said liner comprising a liner head, an elongate substantially axi-symmetric barrel and a milk tube, the liner head and the milk tube being disposed at opposite ends of the barrel, said liner head comprising an opening via which a teat is receivable in the barrel, and said milk tube comprising a tube canal through which milk extracted from a teat in the barrel can be discharged to outside of the teat cup,
wherein the barrel of the liner, when the liner is in a relaxed state, has a length and an average inner diameter, said length and average inner diameter being selected in dependence of the animal species to be milked according to the following table:

| lactating animal | | average inner diameter |
|---|---|---|
| species | length of barrel | of barrel |
| Cow | <100 mm | 20 mm ± 15% |
| sheep, goat | <100 mm | 17 mm ± 15% |

19. The teat cup liner according to claim 18, wherein the inner diameter of the barrel is substantially uniform over the length of the barrel.
